(19) United States
(12) Patent Application Publication
(10) Pub. No.: US 2025/0383286 A1
(43) Pub. Date: Dec. 18, 2025

(54) OPTICAL SENSOR COMPRISING A WINDOW AND A WINDOW MONITORING UNIT AND A METHOD FOR MONITORING THE TRANSPARENCY OF THE WINDOW

(71) Applicant: BEA SA, Angleur (BE)

(72) Inventors: Julie KLESPERT, Liège (BE); Dorothée COPPIETERS, Aywaille (BE); Alain Louis ZAMBON, Saint-Nicolas (BE); Sébastien VAN LOO, Vaux-et-Borset (BE)

(21) Appl. No.: 18/878,708

(22) PCT Filed: Jun. 28, 2023
(86) PCT No.: PCT/EP2023/067742

§ 371 Date: Dec. 24, 2024

(30) Foreign Application Priority Data
Jun. 28, 2022 (DE) 10 2022 116 101.3

(51) Int. Cl. G01N 21/59

(52) U.S. Cl. CPC G01N 21/59; G01N 2201/0636; G01N 2201/08; G01N 2201/105

(57) ABSTRACT

An optical sensor (10) is disclosed. It may comprise a scanning unit (14), a transparent window (20) with a lateral extension (WE) and a height extension (HE) through which a scanning-light can pass, and a window monitoring unit (50) to monitor the transparency of the window (20). The transparent window (20) has at least one inclined window element (52, 56) that has an external element surface (54, 58). The window monitoring unit (50) includes a test-light emitter unit (30) that emits test-light at a plurality of separate emitting positions (EP.X) along the lateral extension (WE), a test-light receiver unit (40) that receives a test-light along a plurality of separate receiving positions (RP.Y) along the width extension (WE), and a determination unit (100) to determine the change of transparency of the window (20) in such way that the test light transmitted along a plurality of light paths (P.X.Y) is analyzed.

The invention refers to an optical sensor according to the preamble of claim 1 and a method for monitoring a window according to claim 16.

An optical sensor with a window monitoring system is disclosed in DE 93 21 155 U1. The optical sensor comprises a transparent window where the window monitoring system comprises emitting diodes that are placed opposite to receiving diodes to generate a light path between each pair of opposite receiving and emitting diodes.

By evaluating the intensity of the received light, the window monitoring unit can determine whether there is soiling of the front window that is not tolerable. In this case a warning can be output at an interface.

This window monitoring system has the drawback that the resolution is given by the spacing of the emitters and receivers and the position of the soiling cannot be determined accurately, especially not in a vertical direction of the window. This means that a warning might be issued although the spot, in particular a dirt spot, does not impact the view of the scanner. The sensor is then put to a stop unnecessarily.

The problem of determining the vertical position of a spot is also not solved by a solution which is known from DE 10 2017 001612 A1 that works with a rotating emitter and receiver setup.

It is the object of the invention to improve the window monitoring system to increase the availability of an optical sensor without impacting its reliability.

The object is solved by an optical sensor according to claim 1 as well as by a method for monitoring a window according to claim 16.

The subclaims are advantageous embodiments of the invention.

In a known way, the optical sensor comprises a transparent window that has a lateral extension and a height extension, through which a scanning-light can pass. The scanning-light can be sent and received by a scanning unit. The window has at least one window element that has an external element surface with an element-width dimension and an element-height dimension.

The optical sensor furthermore comprises a window monitoring unit to monitor the transparency of the window. The window monitoring unit comprises a test-light emitter unit that emits test-light at a plurality of separate emitting positions along the width extension of the window. The emitting positions are positioned at a first end of the window in its height extension.

The window monitoring unit furthermore comprises a test-light receiver unit that receives test-light along a plurality of separate receiving positions along the lateral extension of the window. The test-light receiver unit is disposed at an end of the window opposite to the test-light emitting positions in the height extension.

The test-light emitter unit and the test-light receiver unit are arranged in such a way that the test-light penetrates the at least one external surface of the window.

The optical sensor furthermore comprises a determination unit to determine the change of transparency of the window. The change of transparency may occur due to environmental impacts, like snow, dirt or pollen covering the external surface of the window.

The determination unit comprises a control unit that interacts with the test-light emitter unit and the test-light receiver unit in a way that the test-light transmitted along a plurality of light paths is analysed, especially in respect of the received intensity.

Each light path is defined to extend between a pair of positions, i. e. an emitting position and a receiving position. The emitting positions and the receiving positions are absolute positions distributed in lateral direction of the window in a predefined way.

A light path in the context of the invention is, in an idealized way, regarded as a straight, linear connection between its end positions, namely an emitting position and a receiving position paired therewith, where the linear connection may be vertical or oblique. To evaluate the intensity of a test-light transmitted along a specific light path, the intensity is determined at a time when only the test-light from the paired emitting position is received by the receiving position. The control unit synchronises the measurement by pulsing the emitters whilst measuring the intensity of the test-light received at the paired receiver.

A set of evaluated light paths are predefined in the control unit, where the corresponding intensities are acquired.

According to the invention, the set of evaluated light paths comprises a plurality of light paths, including a first light path and a second light path. The first light path is defined such that it has a first offset between its receiving position and its paired emitting position, and at least a second light path is defined such that it has a second offset between its receiving position and its paired emitting position. According to the invention the first offset and the second offset differ by a defined lateral offset distance and/or in a lateral offset direction. The offset either of the first or the second light path can be zero.

Therefore, the window monitoring unit makes use of a meshed topology of light paths, where the emitting positions are interconnected with the receiving positions by a multiplicity of light paths exhibiting different inclinations. Each individual light path connects a single emitting position with a single receiving position, where each emitting position can interconnect with numerous receiving positions and each receiving position can be connected to multiple emitter positions. This results in a complex lattice of differently inclined light paths between the emitter unit and the receiver unit.

According to this arrangement, the monitoring system allows the test-light that penetrates the external surface of the window to be viewed from different directions. A spot on the window is an obstruction for the test-light between the emitting position and the receiving position. A spot obstructing the light-paths of the same inclination leads to a shadowing effect, which makes it difficult to accurately determine the actual position of the soiling on the window as viewed along these light paths, especially in the vertical direction. Hence, it is an idea of the invention that the shadowing effect of a spot can be reduced by viewing the affected region in which the spot lies at different angles and a height information about the spot can be gained by using differently oblique light paths as some of these will be hindered by the spot, whilst others will be able to pass through the window in an area vertically above or below the spot. The height information can then be used when evaluating the impact of the spot on the reliability of the optical sensor.

Preferably, the difference between at least two lateral offset distances is more than ⅛^{th} especially more than a quarter of the window height, or maybe even more than ½ of the window height. According to this measure a minimum viewing angle is given to allow a fair resolution in the height direction of the window.

According to an advantageous embodiment of the invention, the monitoring system is designed to acquire intensities of a set of evaluated light paths that comprise a subset of crossing light paths containing a first light path and a second light path. Crossing light paths are created when the emitting position of the second light path comprises an offset to the emitting position of the first light path in an emitter offset direction and when the receiving position of the second light path comprises an offset to the receiving position of the first light path in a receiver offset direction that is opposite to the emitter offset direction.

According to this setup the information of the test-light, which preferably produces overlapping regions on the external surface of the window, can be used to increase the capability of determining the position or the extension of a spot in height direction, as the shadowing effect can be further reduced by using a high density of light paths.

According to this feature the resolution of the window monitoring unit is increased, especially in the height dimension, as the test-light is emitted along differently inclined light paths, some of which can pass through spots, thereby eliminating the shadowing effect of a spot which occurs when parallel beams, e.g., parallel to the height axis, are used for monitoring. This is particularly the case when the window comprises two window elements that are inclined relative to each other. This makes it possible to determine which window element the spot is located on, which is not possible by using parallel beams.

According to a further improvement of the window monitoring unit the subset of crossing light paths contains light paths having a single emitting position and a plurality of receiving positions, thus, allowing for a complex meshed topology of light paths, which further increases the resolution of the window monitoring device.

This has the advantage that static emitters can be used, where one emitter can provide the test-light corresponding to a plurality of light paths. The receiving positions can preferably be distributed symmetrically to the emitting position. According to this solution the test-light can be used over its lateral range and consequently light paths are established that “cross” each other in different directions. The crossing in different directions allows an even better vertical resolution of a spot.

In particular, the window has a curved, particularly circular contour, so that the lateral extension is given by the length of the curve. In this case, the emitting and receiving positions are given in an angular position and the offsets are angular distances.

According to a further advantageous embodiment, the window comprises two window elements that lie in succession to each other in height direction, i.e., one above the other in the direction of their extension, and are inclined relative to each other. In this setup the effect of the differently oblique light paths on the resolution in height direction is improved. In this case the determination is possible on which window element the spot is located, and, therefore, it is possible to define different criteria depending on the window element,

Furthermore, the optical sensor may comprise a data memory in which a set consisting of a plurality of fields which map the surface of the window is stored. A transparency value can be assigned to each field. The transparency value is related to the transparency or the change of transparency of the window over time.

This allows to create a transparency map of the window which can be analysed using algorithms to locate the size and position of stains on the external window surface.

The set of fields can be understood as fields of a grid that correspond to the raster of the window surface. For example, the information allocated to each field can be used to create a pixel map of the window. In other words, the information associated with each field can be presented as a digital image, enabling graphic image processing and/or filter algorithms to be used for evaluating the transparency of the window.

In a further advantageous embodiment, the optical sensor comprises a data memory in which a plurality of light path relations is stored, where each light path relation assigns a subset of fields to a specific light path. This allows a defined mapping of the window surface penetrated by the test-light emitted along said light path.

According to a preferred embodiment, the scanning unit comprises a rotating mirror to deflect emitted and received scanning beams, where the test-light receiver unit comprises a test-light receiver and a lightguide. According to this embodiment, the lightguide is attached to the rotating mirror of the scanning unit. The lightguide redirects/guides the test-light between the test-light receiver unit at a plurality of receiving positions and the test-light emitting unit at a plurality of emitting positions. Due to the rotating lightguide a plurality of receiving positions can be easily achieved to provide a high angular resolution.

The control unit particularly comprises an angle determination unit that derives the angular position of the rotating mirror of the scanning unit. Accordingly, due to the angle determination unit the control unit knows the current receiving position depending on the rotating angle of the mirror of the scanning unit.

In a most preferable way, the test-light receiver unit comprises a single light receiver that is the end point to a plurality of light-paths established by a plurality of emitting positions.

Particularly, the plurality of emitting positions are facilitated by a plurality of separate test-light emitters, particularly infrared LEDs, that are distributed, preferably in an equally spaced way, along the scanning angle.

According to a further advantageous embodiment, the test-light emitter unit having a plurality of separate test-light emitters, comprises an emitter shielding that surrounds the separate test-light emitters in a way that the separate test-light emitters are placed inside a parabolic cavity.

According to a further improvement of the optical sensor, the sensor comprises a converging lens that is positioned between the test-light receiver unit and the test-light emitters, where a focal point of the converging lens is close to the test-light emitter. As the light source is close to the focal point the lens shapes an almost parallel beam which exits the lens in the direction of the windows. As the so shaped beam width preferably at least equals the depth of the active region of the window, an improved coverage is provided.

Particularly the converging lens is of a ring like shape, more particularly covering a plurality of test-light emitters.

The control unit is preferably designed in a way that it synchronises a pulsing of a specific test-light emitter at a specific emitting position and the angular positions of the mirror at a specific receiving position to establish a test-light path. According to such a synchronization a plurality of such specific light paths can subsequently be evaluated, so that in cumulation of all the test-light paths the evaluation can be based on the information that is provided by the meshed optical pattern.

A further aspect of the invention includes a method for monitoring the transparency of a window of an optical sensor as previously described.

The determination unit of the window monitoring unit comprises a control unit that executes an acquisition step that measures the intensity of the received test-light for all the light paths that are defined in a set of evaluated light paths.

The determination unit comprises a mapping unit providing a set of fields resembling a map of the external surface of the window. Accordingly, each field is related to an area and a position of the external surface of the window. The set of fields can be understood as grid. Accordingly, the fields in the grid can be fields of a raster map of the external surface of the window, where each field is represented by a pixel. Preferably the grid, namely the relation between the grid field and the external surface, is stored in a memory of the optical sensor.

The mapping unit, furthermore, provides a plurality of light path relations, where a light path relation is an assignment of a subset of fields to a specific light path. The subset of fields belonging to a specific light-path are preferably the fields of the window penetrated by the test-light that is sent along the specific light-path.

The plurality of light path relations is preferably also stored in an internal memory of the optical sensor.

The determination unit comprises a field allocation unit that executes an allocation step in which it allocates a transparency value to a field in a value-allocation process. The transparency value depends on the measured intensity for the corresponding light path.

The value-allocation process is executed for the fields given in the light path relation for the corresponding light path. Accordingly, the value-allocation process can amend all the fields of the grid corresponding to the light path depending on the measured intensity of said light path.

For example, the control unit can determine all the intensities for all the light paths of the set of light paths in a first cycle, where in a following cycle the value-allocation process allocates all transparency-values to the corresponding fields. Alternatively, the control unit can determine an intensity of a light beam corresponding to a single light path, where subsequently the transparency value is assigned to the fields related to this light path. These steps are repeated until all light paths are processed. In any case by parsing all light paths a transparency map of the window is created.

Furthermore, the determination unit comprises a decision unit that executes a decision step. Based on the transparency values allocated to the fields, the decision unit decides whether the transparency of the window is critical and whether to create a corresponding output. The decision unit may decide this based on predefined criteria e.g., global pollution, or the type of pollution, that could be ubiquitously homogeneous on the window or distinctly localized on the window, i.e. limited to a specific size and/or location and displaying a distinct edge. As the pollution can be located precisely the decision can also be made depending on the sector in the grid.

As the decision unit works with the mapped transparency values the criteria for a critical state can easily be adjusted without changing the acquisition or the physical setup of the monitoring system.

The allocation unit, mapping unit and decision unit do not need to be physically separate units. They can all be implemented within a common computational device.

Depending on the result of the decision unit, the output signal can either be a digital signal or provide different information, e.g., a warning, a stop signal or the like. The output signal may be used internally or provided to an external device.

According to an advantageous embodiment, the determination unit derives the transparency value by comparing each measured intensity to a reference intensity that was preferably acquired by an initialisation.

Accordingly, it is possible to determine whether the transparency of the window is lower at the point where the scanning-light penetrates the window than it was at the time of the measurement of the reference intensity.

In particular, the value-allocation process calculates an attenuation value depending on the derivation between measured intensity and the reference intensity, e.g. (I_{Ref}−I_{Meas})/I_{Ref}).

The value-allocation process compares a transparency value to be allocated to a field to a transparency value already allocated to this field. Furthermore, the value-allocation process replaces an allocated transparency value if the value to be allocated is lower than the value already allocated.

In the decision step, after all allocations have been completed, fields of the grid are clustered depending on their value. A critical state can be output in case the size of a cluster exceeds a predefined size (number of fields).

The predefined size of the cluster that results in a critical warning can vary depending on the position of the cluster within the grid.

As the position within the grid corresponds to a position on the external surface of the window the aspect that spots at different positions on the window have a different grade of impact on the operability of the sensor can be taken into account for the evaluation.

Furthermore, preferably at least two different types of pollutions are determined to precisely estimate the attenuation by sector on the scanning-light. There is a distinction between homogeneous and distinctly localized pollution, which by contrast is limited to a specific size and/or location and has a distinct edge. E.g., homogeneous pollution is considered to be the average transparency over a cluster of fields.

According to a further determination aspect a soiling is assessed as distinctly localised pollution if the sum of the number of fields that is above or below a critical transparency value exceeds a predefined number.

The attenuation caused by distinctly localised pollution is then evaluated regarding the smallest transparency values.

Then, the attenuation caused by the addition of homogeneous and distinctly localised pollutions on the scanning-light is estimated.

A warning can be triggered according to the attenuation value in the active region of the window, where the scanning-light is supposed to penetrate the window.

Further advantages, features and potential applications of the present invention may be gathered from the description which follows, in conjunction with the embodiments illustrated in the drawings.

Throughout the description, the claims and the drawings, those terms and associated reference signs will be used as are notable from the enclosed list of reference signs. The drawings show

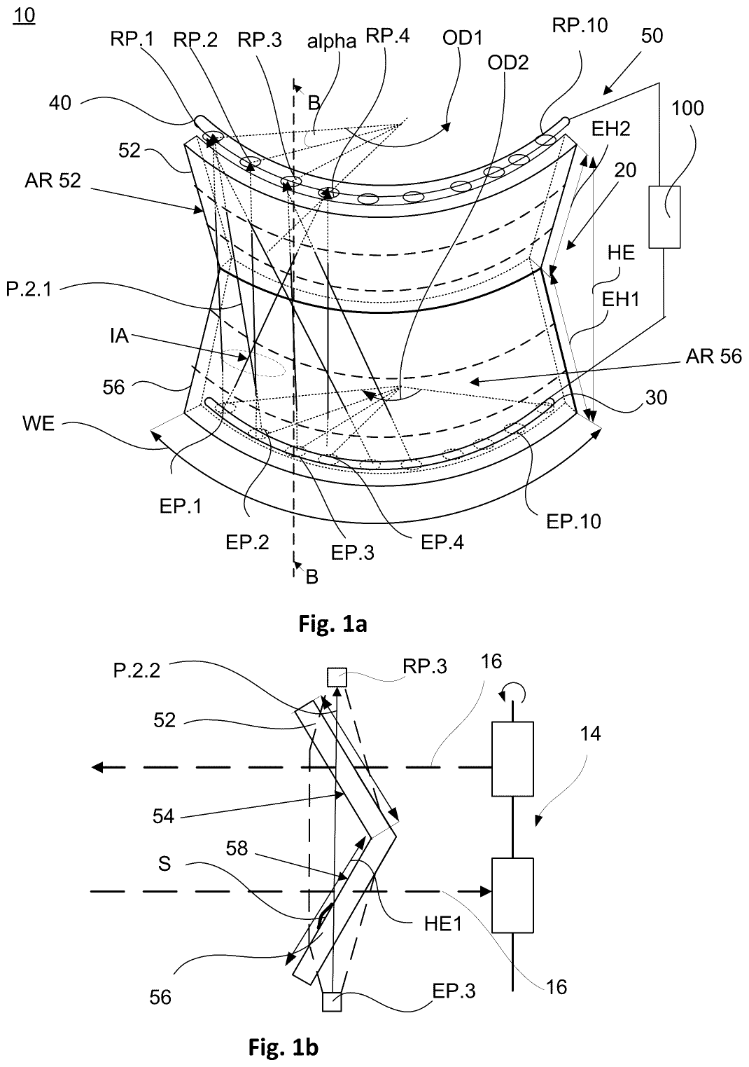

FIG. 1a a schematic perspective view of the window and the receiving and emitting positions of a window monitoring unit;

FIG. 1b a schematic cross-sectional view of the window of FIG. 1a;

FIG. 1c a schematic unrolled view of the window showing light paths;

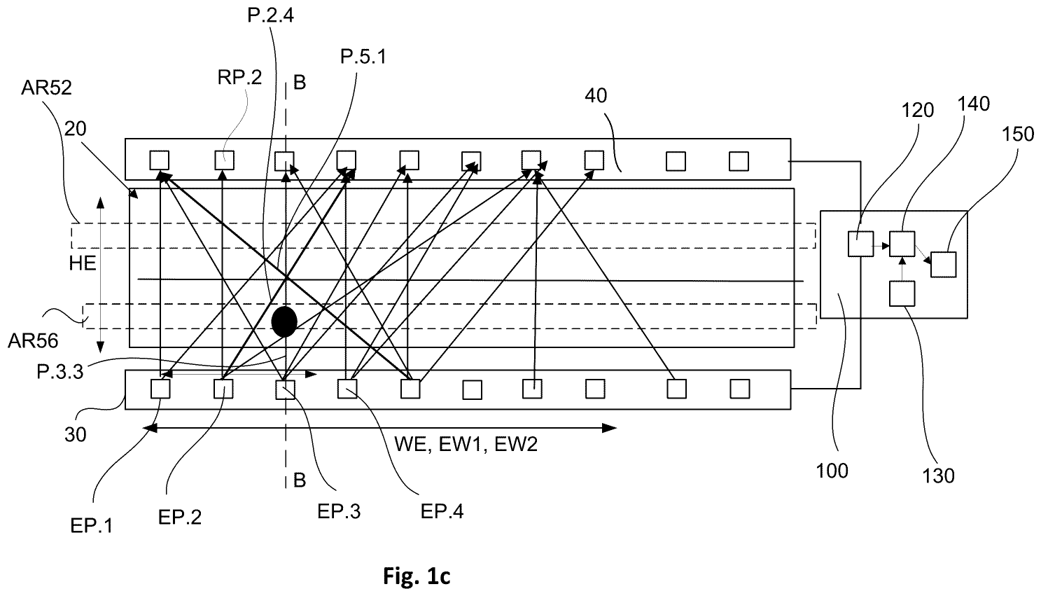

FIG. 2 a grid corresponding to the unrolled view imaging the corresponding areas on the external surface of the window;

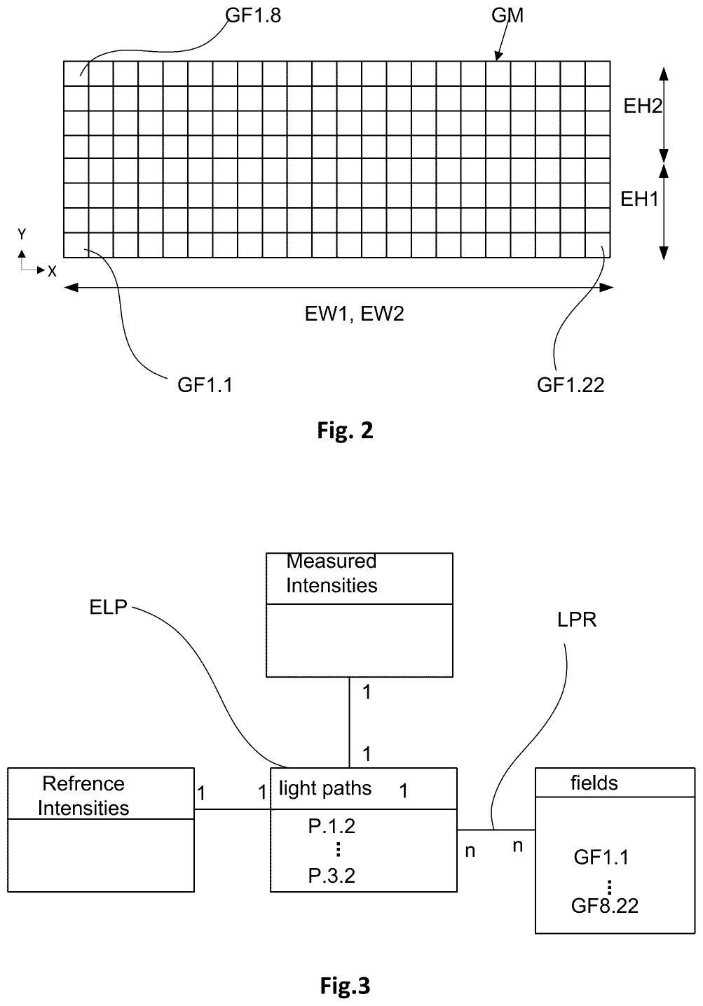

FIG. 3 a symbolic relation between light paths/intensities/fields;

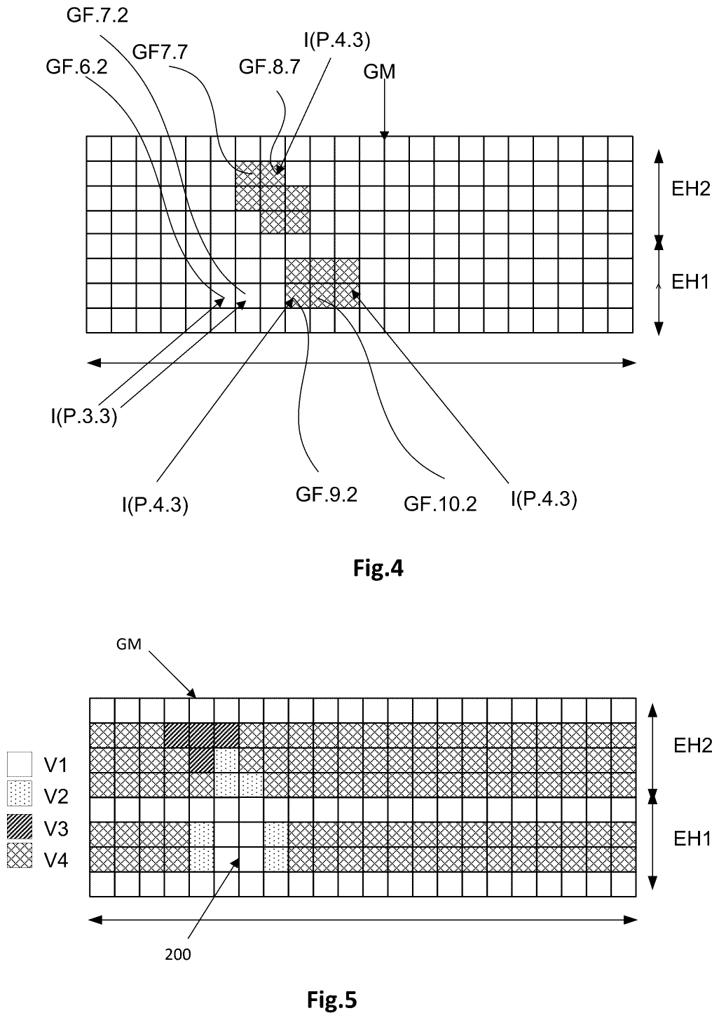

FIG. 4 an example of allocating transparency values to the fields of the grid that are related to a light path;

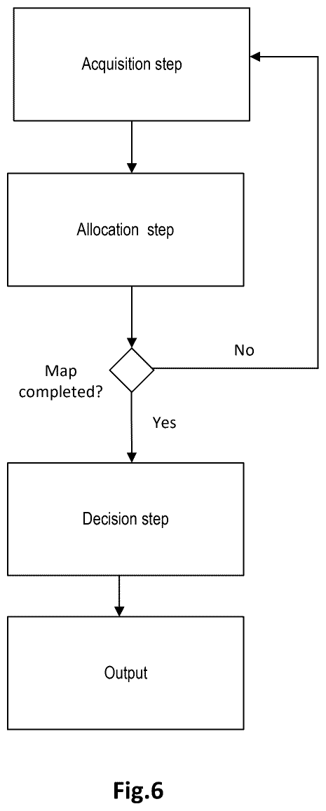

FIG. 5 a map with attenuation values after completed allocation;

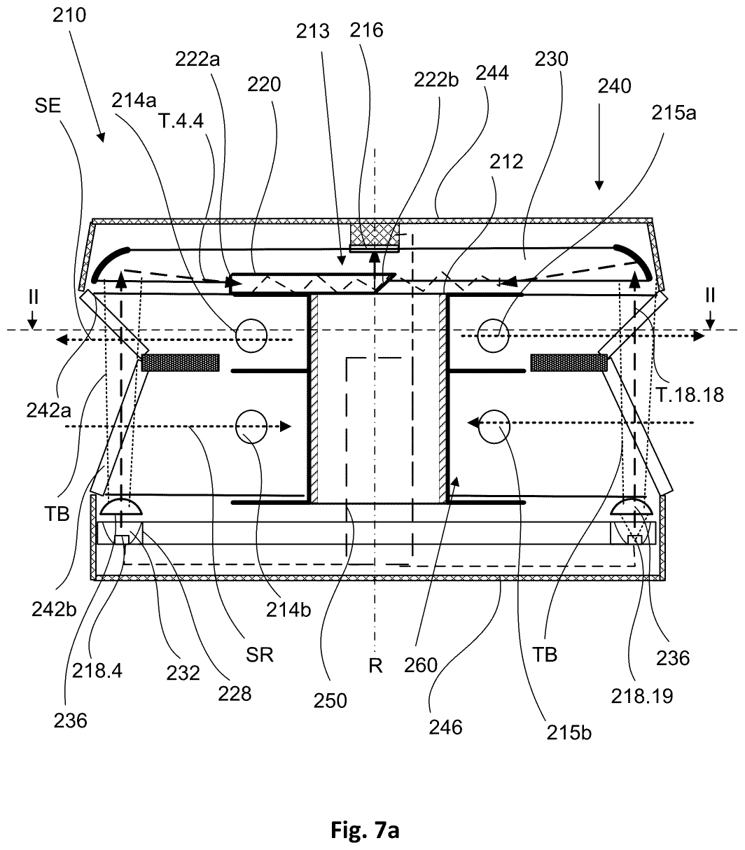

FIG. 6 a flow chart of the method;

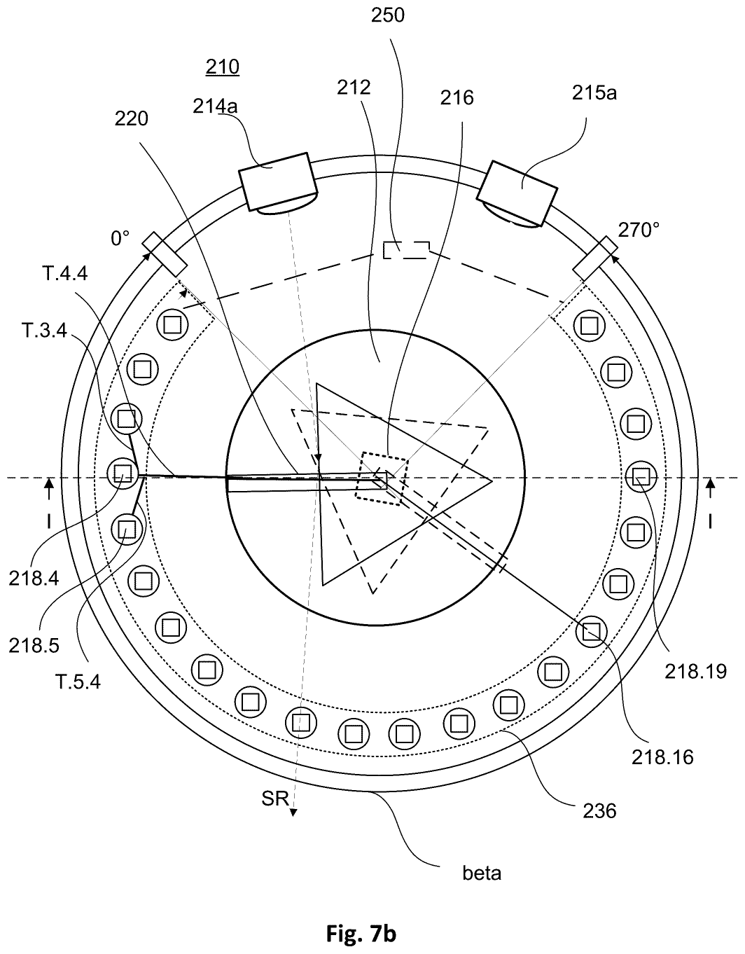

FIG. 7a a cross-sectional view of an embodiment of an optical sensor according to the invention; and

FIG. 7b another cross-sectional view of an embodiment of an optical sensor according to the invention.

FIG. 1a to FIG. 1c show a schematic perspective view of a transparent window 20 of an optical sensor 10. The window 20 comprises two window elements 52, 56. Each window element 52, 56 has a so-called active region AR52, AR56 that represents a partial area of the window 20 and is the region which the outgoing and incoming scanning-lights need to pass through during regular operation of the sensor 10.

As it is an object of the invention to monitor the transparency of the window 20 to assess whether the optical sensor 10 is functioning reliably, the monitoring of the external surface 54, 58 of the window 20 within these active regions AR52, AR56 is important.

The window 20 comprises a lateral extension WE and a height extension HE. The window 20 has an external surface having an element-width dimension EW1, EW2 and an element-height dimension EH1, EH2. The lateral extension in width dimension basically corresponds to the lateral extension WE of the window 20.

The optical sensor 10 comprises a window monitoring unit 50 which monitors the transparency of the window 20, particularly its window elements 52, 56. The window monitoring unit 50 comprises a test-light emitter unit 30 that emits test-light at a plurality of separate emitting positions EP.1, EP.2, . . . EP.10 along the lateral extension WE of the window 20. The emitting unit 30 is located at a first end of the window 20 in height extension HE. In the exemplary embodiment this is at the vertically lower end of the window 20. The window monitoring unit 50 also comprises a test-light receiver unit 40 which is located on the side of the window 20 in height extension HE of the window 20 opposite to the first end of the window.

The receiver unit 40 is embodied in a way to allow the reception of test-light at a plurality of separate receiving positions RP.1, RP.2, RP.3, . . . , RP.10 along the width extension WE of the window 20.

The test-light emitter unit 30 and the test-light receiver unit 40 are arranged in a way that the test-light penetrates the external surfaces 54, 58 of the window elements 52, 56, within their active regions AR52, AR56.

The test-light emitter unit 30 and the test-light receiver unit 40 are shown schematically.

Specifically, the test-light emitter unit 30 can be embodied by comprising separate test-light emitting diodes at the emitting positions EP.1, EP.2, . . . , EP.10 (also referred to as EP.X). The test-light receiving unit 40 can exemplarily be embodied by comprising separate photodiodes at the receiving positions RP.1, RP.2, . . . , RP.10 (also referred to as RP.Y).

Alternatively, the emitter unit 30 can comprise a light emitting diode that moves along the test-light emitting positions and emits light when the diode is at a specific emitting position. Alternatively, the test-light receiver unit 40 can be embodied in a movable way, analogously. In a very preferred embodiment, the emitting unit 30 comprises a plurality of fixed emitters each at an emitting position. The receiving unit 40 comprises a circular mirror element and rotating lightguide, where the lightguide is oriented in lateral direction and the test-light is reflected by a circular mirror that is mounted directly opposite to the emitter unit 30. The lightguide acquires test-light at a plurality of angular receiving positions.

The window monitoring unit 50 furthermore comprises a determination unit 100 to determine the change of transparency of the window elements 52, 56.

The determination unit 100 operates in a way that the intensity of the test-light transmitted along a plurality of evaluated light paths is analysed, i.e., a set of evaluated light paths, which includes at least a first light path and a second light path that differ in their inclinations. Each light path is defined as a straight line between a pair of an emitting position and a receiving position. As the window 20 has a curved contour, the offset of this test-light path is an angular offset. In this example, the emitting positions EP.1, EP.2, . . . , EP.10 and the receiving positions RP.1, RP.2, . . . RP.10 are equally distributed in an angular distance of alpha. It is also possible that the distance between adjacent receiving positions is smaller than the distance between adjacent emitting positions.

The determination unit 100 comprises a control unit 120 that interacts with the test-light emitter unit 30 and the test-light receiver unit 40 to acquire the intensity of test-light beams that are assigned to the set of evaluated light paths. For example, the intensity of a light beam emitted by the emitter unit 30 at the emitting position EP.1 is received by the receiver at the receiving position RP.4. This measured intensity is assigned to the first light path P.1.4. The angular offset angle in this case is 3×alpha in the first offset direction OD1.

Beside the first light path P.1.4, the set of evaluated light paths is defined to contain a second light path, e.g. light path P.2.1. The second light path P.2.1 comprises an offset between its emitting position EP.2 and its receiving position RP.1 that is 1×alpha in a second offset direction OD2 opposite to the first offset direction. Accordingly, the offset of the first light path P.1.4 and of the second light path P.2.1 differ in lateral distance as well as in offset direction.

Furthermore, the emitter EP.2 of the second light path P.2.1 comprises an angular distance of alpha in the first offset direction OD1 to the emitter of the emitting position EP.1 of the first light path P.1.4. The receiving position RP.1 of the second light path P.2.1 comprises an angular distance of 3×alpha in the second offset direction OD2 to the receiving position RP.4 of the first light path P.1.4. The offset direction OD2 is opposite to the first offset direction OD1.

As the offset between the respective receiving positions RP.1, RP.4 and the offset between the respective emitting position EP.1, EP.2 lie in opposite offset directions OD1, OD2 the first light path P.1.4 and the second light path P.2.1 are crossing light paths. As can be seen from the schematic view of FIG. 1a the light beams along the light paths P.1.4 and P.2.1 penetrate an intersecting area IA on the external surface of the window 20.

In this example and in a preferred embodiment the intersecting area IA lies within the lower window element 56, especially within the active area AR56 of the window element 56.

Providing an intersecting area IA that is already within the active area AR56 yet close to the emitter unit 30 allows for reasonable coverage of the lower window element 56.

The control unit 120 of the determination unit 100 executes an acquisition step by triggering a light pulse at the first emitting position EP.1 and evaluating the received intensity of the light beam at the first receiving position RP.4 of the corresponding light path P.1.4 after the light beam has penetrated the window 20, e.g. both window elements 52, 56. The received intensity may be reduced depending on the opaqueness or the size of a spot soiling the penetration area of the light beam. The received intensity is assigned to the respective light path by the determination unit 100 for further evaluation.

According to the invention, preferably a multitude of oblique light paths are defined in order to narrowly cover the window 20 and allow close monitoring of its transparency.

In a preferred embodiment, the angular distance of the emitting positions is between 5° to 15° at a window radius of 35 mm to 45 mm and a window height of 20 mm to 45 mm. The angular distance between the receiving positions is about 0,5° to 10°.

FIG. 1b shows a schematic cross-sectional view of the window 20. FIG. 1b shows a straight light beam corresponding to the idealized light path P.3.3 between the emitting position EP.3 and the receiving position RP.3. It can be seen from the figure that the beam has a depth extension due to which it can create a penetration area on the external surfaces 54, 58 of the window elements 52, 56. The spot S on the external surface of the window 20, especially on the second window element 56, reduces the intensity of the test-light received by the receiver unit 40 at the receiving position RP.3.

Furthermore FIG. 1b schematically shows a scanning unit 14 to send and receive the scanning-light 16. The scanning field in this case is established by sweeping the scanning light along the lateral extension of the window 20.

FIG. 1c shows an unrolled view of the window 20 which can be used to illustrate the effect of the test-light paths having different obliquities. The spot S on the vertically lower second window element 56 blocks the light beam along the light path P.3.3 and causes shadowing on the upper window element 52. If only light paths that are parallel to the light path P.3.3 were provided no height information could be gathered, as none of the test-light beams would penetrate the window in an area vertically above the spot. It can exemplarily be seen that due to the information of an additional light path P.2.4 and/or P.5.1 the spot can be determined to be present on the lower window element 56.

Furthermore, FIG. 1c shows the determination unit 100 which comprises a control unit 120 that measures the intensity of the received test-light for a light path and a mapping unit 130 which provides a grid with a set of fields which relates to an area and a position of the external surface of the window. Furthermore, the mapping unit 130 assigns a subset of fields to a specific light path. The determination unit 100 also comprises a field allocation unit 140 for allocating a transparency value to a specific field and a decision unit 150 which decides whether the transparency of the external surface 54, 58 is critical and whether to create a corresponding output.

FIG. 2 to FIG. 6 illustrate the method according to the invention to determine the change of transparency of the external surface 54, 58 due to environmental impacts.

FIG. 2 shows a grid GM of the window 20 based on a set of fields GF.X.Y provided by the mapping unit 130. The fields GF.X.Y map the window 20, as they correspond to a certain area on the external surface 54, 58 of the window 20. The fields can be used as output data to create an image of the window 20 using raster elements or pixels. In other words, the window 20 can be depicted by a pixel map, where each pixel represents a field. Each pixel has a width corresponding to an angular distance, e.g. 1° and a predefined height corresponding to the extension in the height direction of the elements surface EH1, EH2 of the window elements 52, 56. That means that each field associates with a field area represented by an actual physical surface on the external surface 54, 58 of the window 20. All the fields GF.X.Y represent individual pixels on the map GM and correspond to the same height and the same width on the external surface 54, 58 of the window 20.

The fields GF.X.Y each correspond to a pixel and are designed in a way that they can be assigned to values, i.e. a transparency value. In a preferred embodiment the transparency value is a value that corresponds to the magnitude in change of transparency. This means that a certain light path corresponds to a certain reference intensity when the beam penetrates the window element 52, 56 along a certain light path.

The changes of the intensity in relation to the reference intensity is an attenuation value that is calculated as a percentage e.g. (I_{Ref}−I_{Meas})/I_{Ref}). The intensity corresponds to a light path of the evaluated set of light paths and so does the reference intensity. By representing the set of fields GF.X.Y in the form of a pixel map, the intensity or changes of the intensity can be coded, e. g. colour-coded. This enables the changes in transparency of the window 20 to be viewed as a pictorial image and the transparency can be monitored using graphic image processing and/or filter algorithms.

The mapping unit 130 provides a set of fields GF.X.Y where each field corresponds to a certain area on the external surface of the window 20. The mapping unit 130 also provides a relation as to which fields belong to a certain light path.

FIG. 3 shows a relational diagram according to which the measured intensities, as well as the reference intensities are related to light paths. A reference intensity of a test-light transmitted along a specific light path is determined at a time when only the test-light from the paired emitting position is received by the receiving position. Allocation of the reference intensities to the light paths results in evaluated light paths ELP.

Furthermore, the light paths are related to a plurality of fields assigned to each light path, as shown by the light path relation LPR in FIG. 3.

This allows for the field allocation unit 140 to allocate the attenuation values to all the corresponding fields of the light path.

As the fields can be assigned to several light paths to reflect the intersecting area on the external surface 54, 58 of the window 20, different attenuation values from different light paths may be assigned to the same field. In this case, especially regarding the fact that the transparency value is an attenuation value, a value that is already assigned to a field is replaced by a value that is smaller than the assigned one.

This means that the attenuation value is reduced if there is a transparency in one direction although the field is completely blocked in another direction. In case of using transparency values, all the fields can be preset by an attenuation value corresponding to a “no intensity received” value.

Then, whenever a smaller attenuation value is determined for a light path, the grid is, so to say, cleared along the fields of the light path where the window 20 is found to be transparent.

In the end, after all the attenuation values for all fields have been assigned, there is a map of attenuation values that allows a decision unit 150 to locate and determine the type of pollution of the window 20.

The type of pollution and its position on the window 20 can be used as a basis to decide which status of the sensor is appropriate. Hence the sensor does not have to be put into a critical state whenever a pollution is detected that might not significantly influence the reliability if the optical sensor 10. Hence the availability of the sensor is improved.

A pixel map GM is shown in FIG. 4. In a first allocation step all the pixels are assigned an attenuation value of 100%—white. In a subsequent step the pixels, which belong to a light path, for example the light path P.4.3, are assigned an attenuation value of 0% based on a comparison between measured intensity I(P4.3) and reference intensity for the test-light along the light path P.4.3. The pixels GF9.2, GF10.2 . . . GF7.7, GF8.7 belong to the light path P.4.3, and correspond to the region on the external surface of the window that is penetrated by the test light along the light path P.4.3. Analogous to the example of light path P.4.3. all the pixels GF X.Y. belonging to each of the light paths of the set of evaluated light paths are allocated accordingly. Pixels belonging to several light paths are assigned the value corresponding to the lowest attenuation value and the therefore, to the highest transparency.

FIG. 5 shows an example of a fully allocated map, where all transparency values of all light paths have been allocated. The pixel map GM shows values V1 that correspond to an attenuation of 100%, where V2 corresponds to an attenuation of 50%, V3 to an attenuation of 25% and V4 to an attenuation of 0%. Judging by the V4 region the window 20 is widely transparent. As can be derived from the V1 region there is a nontransparent region 200. According to this image of the map GM the determination unit 100 can derive that there is a spot on the lower window element 56. The region lying vertically above the nontransparent region 200 e.g., is allocated V2, V3 values that have a higher transparency than the nontransparent region 200.

Based on the difference in the transparency values of the pixels and their location on the map GM which represents the areas of the external surface 54, 58 of the window 20, different types of pollution and/or the location and size of pollution can be determined.

Based on these aspects the decision unit 150 can determine whether the transparency situation is critical or not.

FIG. 6 shows a flowchart of a window monitoring process. Firstly, all the intensities for all light paths are acquired. Then transparency values V are allocated to all fields belonging to said light paths.

After the map GM is completed and all transparency values for all evaluated light paths have been assigned to the respective fields, a decision step is executed.

In the decision step, predefined criteria are used to decide which type of pollution can be derived from the allocated map M at which position.

Finally, the decision unit 150 creates an output that triggers a specific action or a signal based on the decision.

FIG. 7a shows a schematic cross-sectional view of an embodiment of an optical sensor 210 according to the invention. The optical sensor 210 comprises a housing 240 having a top cover 244, a lower cover 246 and a window having a first window element 242a and a second window element 242b that are inclined relative to each other. The optical sensor 210 comprises a scanning unit 260 that comprises a scanning-light emitter 214a, 215a, a scanning-light receiver 214b, 215b and a rotating mirror 212 that is rotating around a rotating axis R and deflecting the scanning light to scan the environment over a given angular detection range beta. As can be seen in the schematic cross-sectional view according to II-II in FIG. 7b, the angular detection range in this embodiment is about 270°.

As seen in FIG. 7a the optical sensor 210 comprises a window monitoring unit 250 comprising a plurality of separate test-light emitters 218.1 to 218.22 (also referred to as 218.X) that are embodied as infrared LEDs. Each test-light emitter 218.X defines an emitting position, as previously described. The test-light emitters 218.1 to 218.22 are surrounded by a shielding 228 comprising conical cavities 232 which act as beam shaping cavities to give the light emitted by the test-light emitters 218.X a defined shape, especially a defined opening angle of a conically shaped test-light beam.

The beam shaping cavities 232 allow for spatially very well-defined test-light paths, that especially contribute to a better evaluation of the oblique test-light paths that are generated having an offset between the emitting and the receiving position.

As FIG. 7a furthermore shows, the optical sensor 210 may optionally comprise a convex lens 236 that preferably is of a ringlike shape, as seen from the top (FIG. 7b), and extends over a sector covering all the emitters 218.X. The lens 236 is a converging lens that has its focal point on the side of and close to the emitters 218.X. Hence the lens 236 is, in the cross-sectional view, convexly curved. This e.g. allows a reduction of the angle of the test-light beam TB that is emitted from the lens 236 and that protrudes through the inclined window elements 242a, 242b. This allows an improved coverage of the whole depth of the inclined window-elements 242a, 242b.

Furthermore, the window monitoring unit 250 comprises a test-light receiver unit 213 that comprises a test-light receiver 216 that is embodied as a photodiode. The test-light receiver 216 is aligned with the rotation axis R of the rotating mirror 12 and fixed to the housing 40. Since the test-light receiver 216 does not move during operation of the optical sensor 210, it can easily be electrically connected to be measured by the sensor electronics (not shown).

As can be seen in FIG. 7b, the test-light emitters 218.1 to 218.22 are distributed around the circumference of the window elements 242a, 242b along the angular detection range alpha. The test-light emitters 218.1 to 218.22 emit a light beam that passes through the first window element 242a as well as the second window element 242b generating the test-light paths T.X.Y

According to the invention, the test-light receiver unit 213 comprises a lightguide 220 that is attached to the rotating mirror 212 in such a way that it moves, especially rotates, together with the rotating mirror 212. The lightguide 220 in this embodiment is a prism made of plastic that has a first coupling structure 222a and a second coupling structure 222b. The lightguide 220 is embodied in such a way that the first coupling structure 222a lies in a radial direction of the rotating mirror 212. This means that light, which hits the lightguide 220 in a direction that is basically perpendicular to the rotation axis R, is coupled into the lightguide 220 that is directed to the second coupling structure 222b. The lightguide 220 is embodied in such a way that the second coupling structure 222b decouples the light in a direction that is parallel to the rotation axis R.

According to this embodiment, the test-light receiver 216 is mounted aligned to the rotation axis R, so that the light that is decoupled from the lightguide 220 at the second coupling structure 222b is directly led to the test-light receiver 216.

According to this arrangement the lightguide 220 may receive test-light at all angular positions depending on a current rotation angle of the rotating mirror 212. Accordingly, the receiving positions can be established having a very narrow angular offset between neighboring receiving positions.

According to this arrangement, a plurality of inclined light paths can easily be established to analyze the transparency of the window by a mesh of test-light paths as previously described. For this purpose, the test-light receiver unit 213 makes use of the rotating mirror 212 of the scanning unit 260 to reach the intended receiving positions.

The test-light emitters 218.X are arranged in such a way that the test-light basically travels parallel to the rotation axis R.

Furthermore, the window monitoring unit 250 comprises a circular mirror 230 to deflect the test-light to be received at the receiving positions by the lightguide 220 in radial direction. The circular mirror 230 basically redirects the test-light from an axial to radial direction. Additionally, due to its circularity the circular mirror 30 focuses test-light having a path which is not parallel to the rotation axis R but oblique thereto. This makes use of the phenomenon that the test-light is not emitted as a circular beam but conically.

FIG. 7a shows that the test-light that is emitted from the test-light emitter 218.4 follows the light path T.4.4. In this situation, the test-light is emitted from the test-light emitter 218.4, passes through the second window element 242b and then through the first window element 242a. After passing through the window elements 242a, 242b, the test-light is deflected by the circular mirror 230 from an axial to a radial direction. In the situation that is shown in FIG. 7a the rotating mirror 212 is in a position in that the lightguide 220 in its current receiving position is at the same angular position as is the test-light emitter 218.4. The test-light that is redirected to a basically radial direction hits the first coupling structure 222a basically perpendicularly. The test-light is trapped in the lightguide 220 and guided along the lightguide 220 to its second coupling structure 222b at the center of rotation of the rotating mirror 12. There, the test-light is extracted from the lightguide 220 and guided directly to the test-light receiver 216, being a photodiode that is positioned in alignment with the center of rotation of the rotating mirror 12. The test-light receiver 216 is positioned above the rotating mirror 212 where the test-light sensitive face of the test-light receiver 216 faces the rotating mirror.

FIG. 7a also shows the test-light path T18.18 received by the lightguide 220 and then by the test-light receiver 216 when rotating the rotating mirror by 180°.

FIG. 7b shows a schematic cross-sectional view through the sensor along II-II. The rotating mirror 212 comprises a circular top surface, where the facets of the mirror are arranged in a triangular cross section.

The embodiment of the rotating mirror 212 allows an angular scanning range alpha of about 270°. The lightguide 220 extends from the center of rotation to the circumference of the rotating mirror 12. The lightguide 220 does preferably not exceed the body of the rotating mirror 212. Such an arrangement has a positive influence on the balance of the rotating mirror 212.

The position of the test-light receiver 216 is indicated by the dashed square aligned with the rotation axis R. The test-light that is emitted from the test-light emitter 218.X can be received at various angular positions that the first coupling structure 22a can reach to establish an optical mesh including differently inclined light paths T.X.Y as previously described.

To establish a specific light path, a specific test-light emitter 218.X is pulsed at a specific moment at that the position of the lightguide corresponds to the intended receiving position of the light path. Preferably only light along a single light path is generated at a time as to avoid cross-influences between test-light of different light-paths.

It is obvious that the number of light-paths which can be analyzed corresponds at least to the number of test-light emitters 218.X as the lightguide 220 passes all test-light emitters 218.X during a full rotation of the rotating mirror 212. For each angular position of the lightguide 220 potentially a plurality of light paths can be generated with a plurality of test-light emitters 218.X. This is exemplarily shown by a further angular position where the lightguide 220 has a receiving position opposite to the test-light emitter 218.19. In this case there is no angular offset between the emitting and the receiving position.

A further advantageous effect of the optical sensor 210 according to the invention is that additional test-light paths T.X.Y can be generated by allowing angular offset positions between the first coupling structure 222a and the corresponding test-light emitter 218.X. Such are shown a T.4.3 and T.4.5. This means that the test-light path T.X.Y is generated by the test light emitter 218.X that is illuminated at a time when the first coupling structure 22a has an angular offset to the illuminated, preferably pulsed test-light emitter 218.X. The generated test-light path is then oblique. According to this option a mesh of test-light paths can be created by solely synchronizing the activation of the test-light emitters 218.X with the angular positions of the rotating mirror 212 comprising a specific angular offset between the emitting and receiving position.

This allows an increased number of test-light paths to be created without being limited by spatial conditions. As explained in FIG. 7a the circular mirror 230 improves the level of energy that can be detected in such “offset situations”.

FIG. 7b shows the ringlike shaped lens 236 from a top view stretching over the sector of 270° covering all the first optoelectronic components.

The ringlike shaped lens 236 has the effect that it narrows the cone of the test-light beam TB in its extension in the cross-sectional plane including the rotation axis, while it is not influenced to this extent in the circumferential direction.

### LIST OF REFERENCE SIGNS

10 optical sensor
14 scanning unit
20 window
30 emitter unit
40 receiver unit
50 window monitoring unit
52 first window element
54 external surface of the first window element
56 second window element
58 external surface of the second window element
100 determination unit
120 control unit
130 mapping unit
140 field allocation unit
150 decision unit
210 optical sensor
212 rotating mirror
213 test-light receiver unit
214a scanning-light emitter
214b scanning-light receiver
215a scanning-light emitter
215b scanning-light receiver
216 test-light receiver
218.X test-light emitters
220 lightguide
222a first coupling structure
222b second coupling structure
226 window monitoring unit
228 shielding
230 circular mirror
232 conical cavities
236 converging lens
240 housing
242a first window element
242b second window element
244 top cover
246 lower cover
250 window monitoring unit
260 scanning unit
AR52, AR56 active region
EH1 element-height dimension
EH2 element-height dimension
EP.X emitting position
GM map
GF.X.Y field
HE height extension
I(P X.Y) Intensities for light path P X.Y
IA intersecting area
LPR light path relation
LPS light path set
P.X.Y light path between emitting position X, receiving position Y
RP.Y receiving position
T.X.Y light path between emitting position X, receiving position Y
V transparency value
WE lateral extension

1. (canceled)

2. (canceled)

3. (canceled)

4. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

20. (canceled)

21. (canceled)

22. (canceled)

23. (canceled)

24. (canceled)

25. An optical sensor (10), comprising:
a scanning unit (14);
a transparent window (20) that has a lateral extension (WE) and a height extension (HE) through which a scanning-light can pass; and
a window monitoring unit (50) to monitor the transparency of the window (20),
wherein:
the transparent window (20) has at least one inclined window element (52, 56) that has an external element surface (54, 58);
the window monitoring unit (50) includes:
a test-light emitter unit (30) that emits test-light at a plurality of separate emitting positions (EP.X) along the lateral extension (WE) of the window (20) at a first end of the window (20) seen in height extension (HE);
a test-light receiver unit (40) that receives a test-light along a plurality of separate receiving positions (RP.Y) along the width extension (WE) of the window (20) at the end of the window (20) opposite to the test-light emitting positions (EP.X) regarding the height direction; and
a determination unit (100) to determine the change of transparency of the window (20) in such way that the test light transmitted along a plurality of light paths (P.X.Y) is analyzed;
the test-light emitter unit (30) and the test-light receiver unit (40) are configured such that the test-light penetrates the external element surface (54, 58);
each light path (P.X.Y) is defined as a straight line between a pair of an emitting position (EP.X) and a receiving position (RP.Y) the determination unit (100) comprises: a control unit (120) that interacts with the test-light emitter unit (30) and the test-light receiver unit (40) to acquire the intensity (I(P.X.Y)) of a test-light beam assigned to a light path (P.X.Y);
a set of evaluated light paths (LPS) comprises a plurality of light paths (P.X.Y) of which, at least a first light path (P.1.2) is defined such that it has a first offset between its receiving position (RP.2) and its paired emitting position (EP.1); and
at least a second light path (P.2.1) is defined such that it has a second offset between its receiving position (RP.1) and its paired emitting position (EP.2), where the second offset differs to the first offset by a defined lateral offset distance and/or in a lateral offset direction.

26. The optical sensor of claim 25, wherein the lateral offset distance is more than ⅛^{th} of the window height extension (HE).

27. The optical sensor of claim 25, wherein the lateral offset distance is more than ¼^{th} of the window height extension (HE).

28. The optical sensor of claim 25, wherein:
the control unit is configured to acquire intensities of a set of evaluated light paths (LPS) that comprise a subset of crossing light paths containing a first light path (P.1.2) and a second light path (P.2.1);
the emitting position (EP.2) of the second light path (P.2.1) comprises an offset to the emitting position (EP.1) of the first light path (P.1.2) in an emitter offset direction (EOD); and
the receiving position (RP.1) of the second light path (2.1) comprises an offset to the receiving position (RP.2) of the first light path (P.1.2) in a receiver offset direction (ROD) opposite to the emitter offset direction (EOD).

29. The optical sensor of claim 25, wherein:
the window (20) comprises a curved contour, such that the lateral extension is given by the length of the curve, and the offset is an angular offset.

30. The optical sensor of claim 29, wherein the curved contour is a circular contour.

31. The optical sensor of claim 25, wherein:
the window (20) comprises two window elements (52, 56), that are arranged sequentially in height direction and are inclined relative to one another.

32. The optical sensor of claim 25, wherein:
that the window (20) is mapped as a grid (GM) consisting of a plurality of fields (GF) which are stored in a data memory, where a transparency value can be assigned to a field (GF).

33. The optical sensor of claim 32, wherein:
the data memory stores a plurality of light path relations (LPR.P.X.Y), where each light path relation (LPR) assigns a subset of fields (GF.X.Y) to a specific light path (P.X.Y).

34. The optical sensor of claim 25, wherein:
the scanning unit comprises a rotating mirror;
the test-light receiver unit (217) comprises a test light-receiver (216);
the test-light emitting unit comprises a test-light emitter; and
at least one of the test-light receiver unit (217) and the test-light emitting unit comprise a lightguide (220),
wherein:
the lightguide (220) is attached to the rotating mirror (212) of the scanning unit (260); and
the lightguide (220) guides the test-light between the test-light receiver unit (217) at a plurality of receiving positions and the test-light emitting unit at a plurality of emitting positions.

35. The optical sensor of claim 34, wherein:
the control unit (120) comprises an angle determination unit that derives the angular position of the rotating mirror of the scanning unit.

36. The optical sensor of claim 34, wherein:
the test light receiver unit (217) comprises a single light receiver (216) that is an end point to a plurality of light-paths established by a plurality of emitting positions.

37. The optical sensor of claim 35, wherein:
the test light receiver unit (217) comprises a single light receiver (216) that is an end point to a plurality of light-paths established by a plurality of emitting positions.

38. The optical sensor of claim 36, wherein:
the light-emitter comprises a plurality of separate test-light emitters (218.X) distributed along the scanning angle.

39. The optical sensor of claim 38, wherein:
each of the plurality of separate test-light emitters (218.X) is an infrared LED.

40. The optical sensor of claim 38, wherein:
the test-light emitter unit (221) comprises an emitter shielding (228) that surrounds the separate test-light emitters (218.X) such that the separate test-light emitters (218.X) are placed inside a parabolic cavity.

41. The optical sensor of claim 39, wherein:
the test-light emitter unit (221) comprises an emitter shielding (228) that surrounds the separate test-light emitters (218.X) such that the separate test-light emitters (218.X) are placed inside a parabolic cavity.

42. The optical sensor of claim 25 wherein:
the test-light emitter unit (221) comprises test-light emitters (218.X) and a converging lens (236) that is placed between the test-light emitters (218.X) and the test-light receiver unit (213); and
a focal point of the converging lens (236) is close to the test-light emitters (218.X).

43. The optical sensor of claim 25, wherein:
the test-light emitter unit (221) comprises test-light emitters (218.X) and a converging lens (236) that is placed between the test-light emitters and the test-light receiver unit (213);
and the test-light emitter unit (221) has a ring-like shape.

43. The optical sensor of claim 35, wherein:
the control unit synchronizes a pulsing of a specific test-light emitter (218.X) at a specific emitting position and the angular positions of the mirror (212) at a specific receiving position to establish a test-light path.
